(19) United States
(12) Patent Application Publication
(10) Pub. No.: US 2006/0197245 A1
(43) Pub. Date: Sep. 7, 2006

(54) METHOD OF MANUFACTURING HEAT PIPE HAVING SINTERED POWDER WICK

(76) Inventors: Ching-Tai Cheng, Shenzhen (CN); Jung-Yuan Wu, Shenzhen (CN); Chu-Wan Hong, Shenzhen (CN); Chang-Ting Lo, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,192

(22) Filed: Dec. 19, 2005

(30) Foreign Application Priority Data
Jan. 14, 2005 (TW) 094101105
Mar. 18, 2005 (TW) 094108405

(51) Int. Cl. F27D 1/16; E04B 1/16; B29C 63/06

(52) U.S. Cl. 264/30; 264/35; 264/171.17; 264/171.27

(57) ABSTRACT

A method is disclosed to produce a heat pipe with a sintered powder wick formed inside the heat pipe. The method employs tape-casting technology to firstly produce thin sheets of powder and then these sheets are sintered to form the wick. In the tape casting procedure, a slurry of the powders necessary to construct said wick is cast onto a moving surface to form a slurry layer and then the slurry layer is dried to form a green tape. The green tape is rolled onto a mandrel and then is inserted into a hollow casing and sintered to cause the powders in the green tape to diffusion-bond together. Thus, the sintered powder wick is constructed.

### DESCRIPTION

1. Field of the Invention

The present invention relates generally to an apparatus for transferring or dissipating heat from heat-generating components such as electronic components, and more particularly to a method of manufacturing a sintered heat pipe.

2. Description of Related Art

Heat pipes have excellent heat transfer performance due to their low thermal resistance, and therefore are an effective means for transfer or dissipation of heat from heat sources. Currently, heat pipes are widely used for removing heat from heat-generating components such as central processing units (CPUs) of computers. A heat pipe is usually a vacuum casing containing therein a working fluid, which is employed to carry, under phase transitions between liquid state and vapor state, thermal energy from one section of the heat pipe (typically referring to as the “evaporating section”) to another section thereof (typically referring to as the “condensing section”). Preferably, a wick structure is provided inside the heat pipe, lining an inner wall of the casing, for drawing the working fluid back to the evaporating section after it is condensed at the condensing section. Specifically, as the evaporating section of the heat pipe is maintained in thermal contact with a heat-generating component, the working fluid contained at the evaporating section absorbs heat generated by the heat-generating component and then turns into vapor. Due to the difference of vapor pressure between the two sections of the heat pipe, the generated vapor moves towards and carries the heat simultaneously to, the condensing section where the vapor is condensed into liquid after releasing the heat into ambient environment by, for example, fins thermally contacting the condensing section. Due to the difference of capillary pressure developed by the wick structure between the two sections, the condensed liquid is then wicked back by the wick structure to the evaporating section where it is again available for evaporation.

The wick structure currently available for heat pipes includes fine grooves integrally formed at the inner wall of the casing, screen mesh or bundles of fiber inserted into the casing and held against the inner wall thereof, or sintered powder combined to the inner wall by sintering process. Among these wicks, the sintered powder wick is preferred to the other wicks with respect to heat transfer ability and ability against gravity of the earth.

Currently, a conventional method for making a sintered powder wick includes filling powders necessary to construct the wick directly into a hollow casing which has a closed end and an open end. A mandrel has been inserted into the casing through the open end of the casing; the mandrel functions to hold the filled powders against an inner wall of the casing. Then the powders are sintered at high temperatures to form the wick. However, this method is unfavorable to construct a uniform wick in that it is difficult to control the pore size distribution over the wick formed. The pore size distribution of a wick, however, has a great impact on the performance of that wick, since excessively small pore size will generate a large flow resistance to the condensed liquid to flow back and excessively large pore size will noticeably decrease the capillary force that is needed to draw the condensed liquid back. Therefore, a wick that has an uneven pore size distribution will greatly affect its performance in conveying the condensed liquid, and sometimes will cause the heat pipe incorporating that wick to suffer dry-out problem at the evaporating section when the condensed liquid is not timely sent back to that evaporating section.

Therefore, it is desirable to provide a method of manufacturing a sintered heat pipe which can effectively control the pore size distribution over the wick of the sintered heat pipe.

### SUMMARY OF INVENTION

The present invention relates to a method of manufacturing a heat pipe having a sintered powder wick formed inside the heat pipe. The method employs tape-casting technology to produce thin sheets of powder. These sheets are then sintered to form the wick of the heat pipe. A preferred method includes the following steps: (1) providing a slurry of the powders necessary to construct said wick; (2) casting the slurry onto a moving surface; (3) drying the slurry on the moving surface to form a green tape; (4) rolling the green tape onto a mandrel; (5) inserting the mandrel and the green tape into a hollow casing which has a closed end and an open end, whereby the green tape is held against an inner wall of the casing by the mandrel; (6) sintering the green tape into a wick on the inner wall of the casing; (7) removing the mandrel from the wick and the casing through the open end of the casing; and (8) filling a working fluid into the casing via the open end thereof and sealing the open end of the casing.

The advantage of the casting procedure in relation to other methods, e.g. the conventional sintering process, is that the powders necessary to construct the sintered powder wick are evenly mixed or distributed in the mixture of the slurry. Therefore, the sintered powder wick constructed from this procedure has a uniform structure in the pore size distribution over the wick formed, which is contributory to eliminating the dry-out problem and increasing the heat transfer performance of the heat pipe employing this wick. Also coupled with the procedure is the advantage of a high manufacturing capacity and an economical production.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is a longitudinal cross-sectional view of a sintered heat pipe in accordance with the present invention;

FIG. 2 is a radial cross-sectional view of the heat pipe of FIG. 1;

FIG. 3 is a flow chart showing a preferred method of making the sintered heat pipe of FIG. 1;

FIG. 4 is a schematic view of a casting machine for performing a casting step of the method of FIG. 3;

FIG. 5 is an isometric view of a green tape made by the casting machine of FIG. 4;

FIG. 6 is an isometric view of the green tape of FIG. 5, but showing the green tape rolled onto a mandrel;

FIG. 7 is similar to FIG. 6, but showing the green tape and the mandrel partially received in a hollow casing, thereby forming an assembly;

FIG. 8 is a longitudinal cross-sectional view of the assembly of FIG. 7;

FIG. 9 is similar to FIG. 2, but showing a wick having a two-layer structure;

FIG. 10 is similar to FIG. 6, but showing two green tapes rolled onto a mandrel;

FIG. 11 is similar to FIG. 8, but showing two green tapes;

FIG. 12 is similar to FIG. 1, but showing a more complex wick structure;

FIG. 13 is an isometric view of an assembly of plural green tapes made by the casting machine of FIG. 4;

FIG. 14 is an isometric view of the assembly of FIG. 13, but showing the assembly rolled onto a mandrel; and

FIG. 15 a longitudinal cut-view of the assembly of FIG. 14 after the assembly is inserted into a hollow casing.

### DETAILED DESCRIPTION

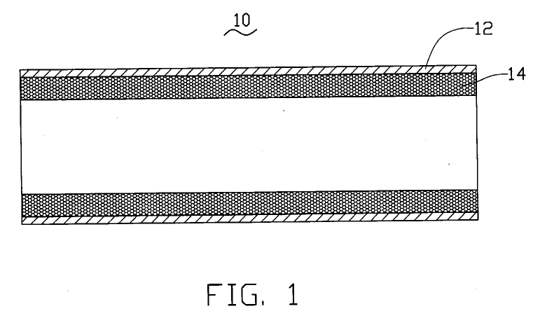

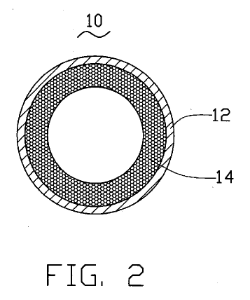

FIGS. 1-2 illustrate a sintered heat pipe 10 formed in accordance with a method of the present invention. The sintered heat pipe 10 includes a casing 12 and a sintered powder wick 14 arranged against an inner wall of the casing 12. The casing 12 is made of high thermally conductive material such as copper or aluminum. Although the casing 12 illustrated is in a round shape, it should be recognized that other shapes, such as polygon, rectangle, or triangle, may also be suitable. The wick 14 is saturated with a working fluid (not shown), which acts as a heat carrier when undergoing phase transitions between liquid state and vaporous state. The sintered powder wick 14 is a porous structure and is formed by sintering process, in which small-sized powders are sintered together under high temperatures. The heat pipe 10 is vacuumed. Although it is not shown in the drawings, it is well known by those skilled in the art that two ends of the heat pipe 10 are sealed.

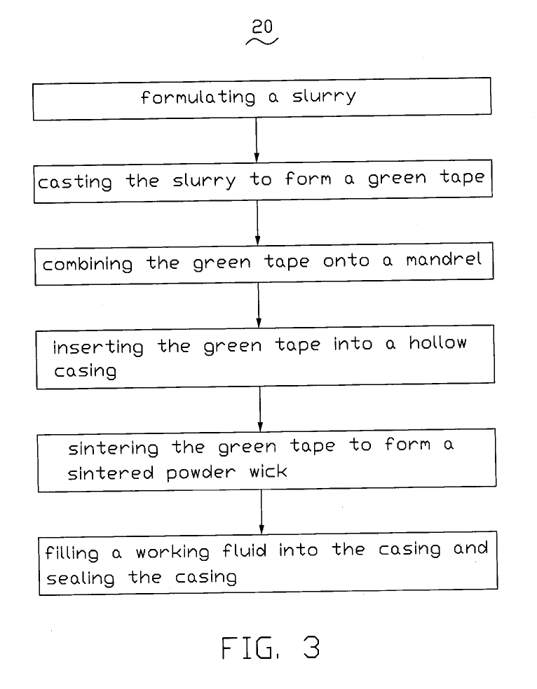

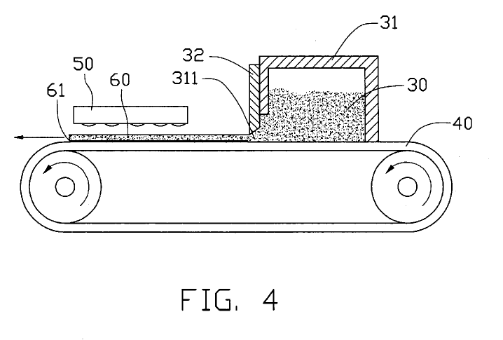

In the present invention, a method 20, as shown in FIG. 3, is proposed to construct the heat pipe 10. The method 20 includes a step of tape casting which is a shape forming technique for powders. The tape casting is capable of converting powders into thin flat sheets. With reference to FIG. 4, a casting machine is illustrated to carry out the tape casting step of the method 20 as shown in FIG. 3. The casting machine includes a storage container 31 in which a slurry 30 is contained, and a casting blade 32 affiliated to an sidewall (not labeled) of the storage container 31. In this casting process, the formation of the slurry 30 is a critical step. The slurry 30 is obtained by mixing the necessary powders, for example, metal powders or ceramic powders, with a solvent, a binder and, if desirable, some other additives. These components are mixed together in a certain proportion either by weight or by volume. For example, they may be mixed by weigh in the proportion that the powders account for 40˜80 percent, the solvent accounts for 10˜40 percent and the binder accounts for 5˜25 percent. The solvent, which is used to lower the viscosity of the slurry so that the slurry can flow more easily, may be selected from organic material such as ethanol, xylene or the like, which is sensitive to temperature. The binder is used to increase the strength of the green cast tape, i.e., the product formed by the casting procedure, and may be selected from polyvinyl alcohol (PVA), polyvinyl butyral (PVB), acrylic resin or the like. Other additives that are desirable may include a dispersant to stabilize the powder against colloidal forces and a plasticizer to modify the properties of the binder. The dispersant may be selected from fish oil such as menhaden fish oil, and the plasticizer may be selected from butyl benzyl phthalate or polyethylene glycol.

The storage container 31 defines a gap 311 at that sidewall to which the casting blade 32 is affiliated. During the casting process, the slurry 30 flows from the storage container 31 via the gap 311 onto a flat support surface, for example, a carrier belt 40 as shown in this embodiment, which is continuously moved with a controlled velocity under the container 31 by two rollers (not labeled). As the slurry 30 is drawn out and spread onto the carrier belt 40 from the container 31 by the movement of the carrier belt 40, the casting blade 32 scrapes over the slurry 30 to produce a slurry layer on the carrier belt 40 with uniform thickness. The thickness of the slurry layer is controlled by a height of the casting blade 32 above the carrier belt 40 and therefore is adjustable by regulating the position of the casting blade 32 in relation to the carrier belt 40. The slurry layer then passes through a drying zone, for example, an array of infrared lamps 50 located above the carrier belt 40 as shown in this embodiment, in order to remove the solvent from the slurry layer. It is recognized that by passing the slurry layer through a drying chamber will also serve the drying purpose. Since only a relatively low temperature is needed to fulfill the drying process, the binder contained in the slurry layer is not removed. After the drying process, a green tape 60 is thus formed, which is very flexible, due to the additives, and easy to handle. The binder gives the green tape 60 enough green strength for it to be removed from the carrier belt 40 without damage. Typically, a bottom of the green tape 60 generally will accumulate a relatively larger amount of the binder than other portions of the green tape 60, thus forming a bonding layer 61 at that position.

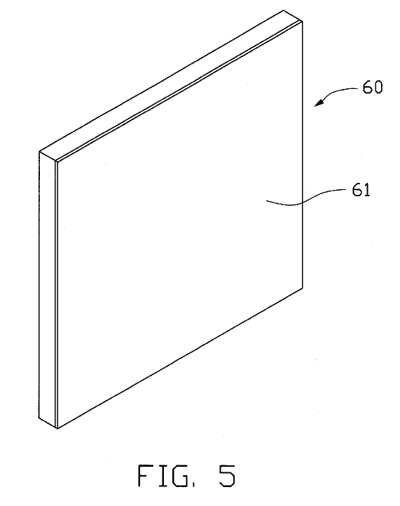

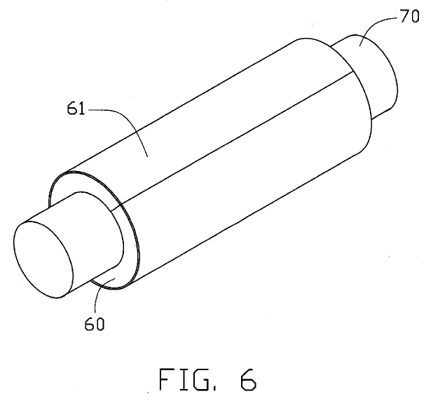

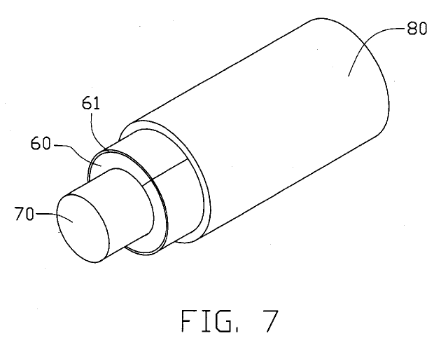

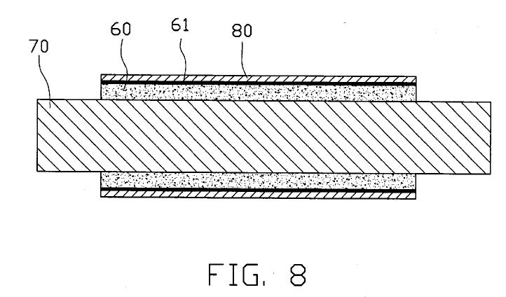

The green tape 60 is then cut with lasers or blades into desired shapes, depending on the specific requirements, as shown in FIG. 5. The cut tape 60 is then combined to a mandrel 70 by rolling onto an outer surface thereof, as illustrated in FIG. 6, with the bonding layer 61 exposed in the air. The mandrel 70 may be a solid column made of stainless steel material. The shape of the mandrel 70 may vary according to the shape or structure of the heat pipe to be formed. Then, the mandrel 70, together with the cut tape 60 rolled thereon, is inserted into a hollow metal casing 80, as shown in FIGS. 7-8. Although it is not shown in the drawings, the metal casing 80 has an open end and a closed end. The mandrel 70 with the tape 60 rolled thereon is inserted into the metal casing 80 through the open end thereof. The cut tape 60 is held against an inner wall of the casing 80 by the mandrel 70. The binding layer 61 engages with the inner wall of the casing 80. The cut tape 60 is then sintered under a high temperature to thereby produce the sintered powder wick 14 of the heat pipe 10 as shown in FIGS. 1-2. Specifically, the cut tape 60 is firstly sintered at about 450˜500 degrees Celsius to burn out the binder (including the binding layer 61) contained in the green tape 60, and then sintered at about 500˜1000 degrees Celsius for about 10˜60 minutes—if the powders used to form the tape 60 are copper powders—to cause the powders to be diffusion-bonded together. After this sintering process, the mandrel 70 is drawn out of the casing 80. Finally, the casing is vacuumed and a working fluid such as water, alcohol, methanol, or the like, is injected into the casing 80 via the open end, and then the open end of the casing 80 is hermetically sealed to form the heat pipe 10.

The advantage of the casting procedure in relation to other methods, e.g. the conventional sintering process, is that the powders necessary to construct the sintered powder wick 14 are evenly mixed and distributed in the mixture of the slurry 30 due to the additives. Therefore, the sintered powder wick 14 constructed from this procedure has a uniform structure in the pore size distribution over the wick 14, which is contributory to increasing the heat transfer performance of the heat pipe employing this wick 14. Also coupled with the procedure is the advantage of a high manufacturing capacity and an economical production.

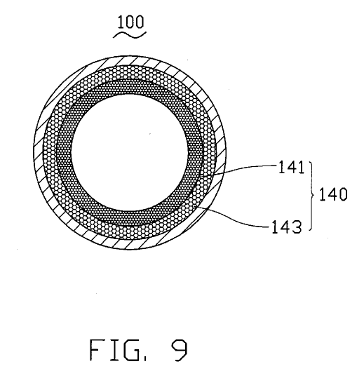

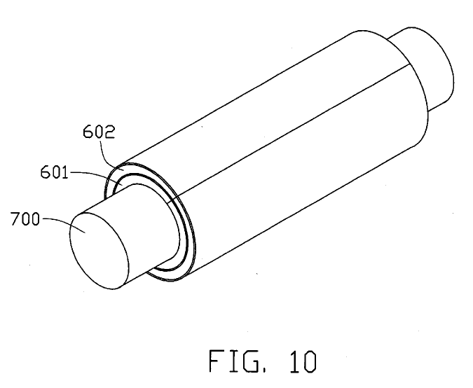

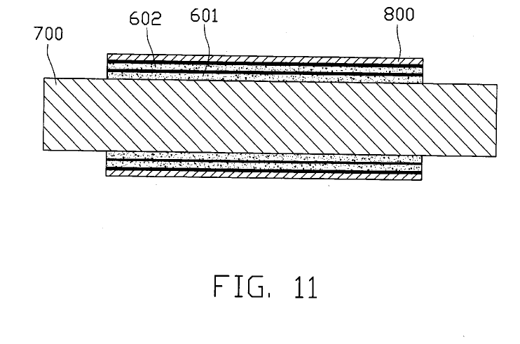

Referring to FIGS. 9-11, the casting procedure as shown above is also capable of producing a heat pipe 100 with a multi-layer sintered powder wick 140. The wick 140 has a composite, two-layer structure, i.e., the inner layer 141 and the outer layer 143, wherein the outer layer 143 is connected to an inner wall of the heat pipe 100. The inner and outer layers 141, 143 are constructed from powders that have different particle sizes. As illustrated in this embodiment, the outer layer 143 has a larger particle size than that of the inner layer 141. For constructing this wick 140, two layers of green tape 601, 602 with different powder sizes are necessary. By using the above-mentioned casting procedure, each of the green tapes 601, 602 can be easily obtained by producing from different slurries that are mixed with powders having different powder sizes. Then, the tapes 601, 602 are stacked together and rolled onto a mandrel 700 with the small powder-sized tape 601 contacting an outer surface of the mandrel 700, as shown in FIG. 10. The mandrel 700 with the tapes 601, 602 combined thereto is then inserted into a hollow casing 800, and the tapes 601, 602 are sintered at high temperatures so as to form the two-layer wick 140 of the heat pipe 100.

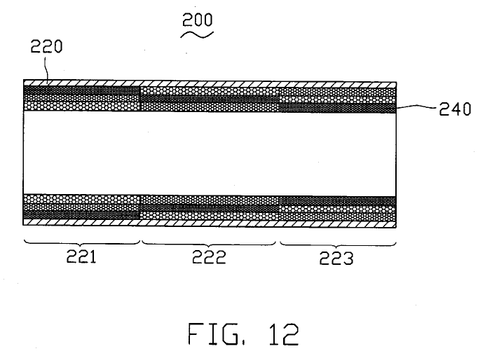

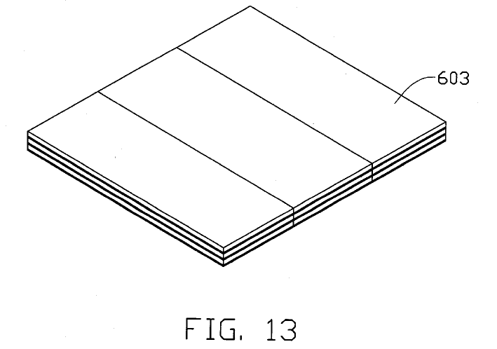

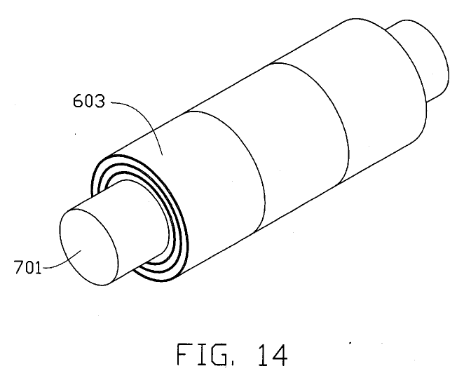

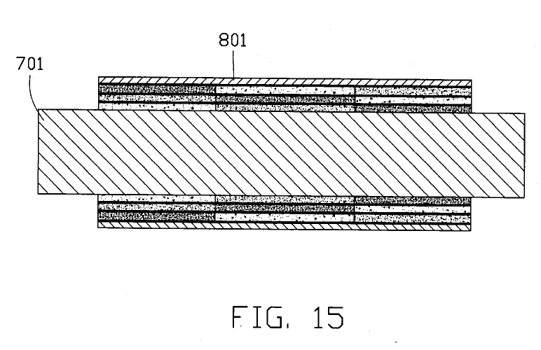

Referring to FIG. 12-15, the above-mentioned casting procedure is also applied to produce a multi-layer heat pipe 200 with an even more complex wick structure 240. The sintered powder wick 240 is arranged against an inner wall of a casing 220 of the heat pipe 200 and has a three-layer structure along a radial direction of the casing 220. The casing 220 includes three consecutive sections 221, 222, 223 and each layer of the wick 240 is also divided into three sections (not labeled) along a longitudinal direction of the casing 220, corresponding to the three section 221, 222, 223 of the casing 220. Every three sections of the wick 240 that are stacked corresponding to a single section of the casing 220, may have different particle sizes to each other. For constructing this wick 240 by using the foregoing casting procedure, a large number of green tapes are needed. As shown in FIG. 13, nine green tapes 603 are stacked together in three rows in such manner that corresponds to the arrangement of the wick 240. Each tape 603 is to be formed as one section of one layer of the wick 240. The nine green tapes 603 have been made by the above-mentioned casting step from powders of three different powder sizes. The three stacked tapes 603 have the powder sizes different from each other. Since these tapes 603 formed by the tape casting procedure are very flexible, they are easy to be rolled onto a mandrel 701, as shown in FIG. 14. Then, the mandrel 701 is inserted into a hollow casing 801, as shown in FIG. 15, and these tapes 603 are sintered so as to form the wick 240.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing a heat pipe having a sintered powder wick formed inside the heat pipe comprising steps of:
a). forming a slurry by mixing powders necessary to construct said wick with a solvent and a binder;
b). spreading said slurry into a thin layer on a support surface;
c). drying said slurry layer to form a green tape;
d). inserting said green tape into a hollow casing;
e). sintering said green tape in said casing to cause the powders in the green tape to diffusion-bond together; and
f). filling a working fluid into said casing and sealing the casing.

2. The method of claim 1, wherein said slurry-spreading step comprises spreading said slurry onto the support surface from a storage container in which said slurry is contained, via a gap defined at a sidewall of the storage container.

3. The method of claim 2, wherein said support surface is defined by a surface of a carrier belt which is moved under the storage container.

4. The method of claim 1, wherein the step b) further comprises scraping over said slurry as said slurry is spread onto said support surface so as to control a thickness of thin layer formed by the slurry.

5. The method of claim 1, wherein the step d) further comprises combining said green tape onto a mandrel so as to hold the green tape against an inner wall of the casing by the mandrel when the green tape is inserted into said casing.

6. The method of claim 1, wherein the powders, the solvent and the binder are mixed by weigh in the proportion that the powders account for 40˜80 percent, the solvent accounts for 10˜40 percent and the binder accounts for 5˜25 percent.

7. The method of claim 1, wherein said wick inside said heat pipe has a composite structure and is formed by sintering multiple green tapes that are respectively produced from slurries having different powder sizes.

8. The method of claim 1, wherein the powders are selected from one of metal powders and ceramic powders.

9. A method for manufacturing a heat pipe having a sintered powder wick arranged against an inner wall of the heat pipe comprising the following steps:
providing a slurry of the powders necessary to construct said wick;
casting the slurry onto a moving surface;
drying the slurry on the moving surface to form a green tape;
rolling the green tape onto a mandrel;
inserting the mandrel and the green tape into a hollow casing, whereby the green tape is held against an inner wall of the casing by the mandrel;
sintering the green tape;
removing the mandrel from the casing; and
filling a working fluid into the casing and sealing the casing.

10. The method of claim 9, wherein the casting step further comprising controlling a thickness of the green tape formed from said slurry.

11. The method of claim 9, wherein at least another green tape that has a different powder size from that of said green tape is provided, and said green tape and said at least another green tape are rolled together onto said mandrel and are inserted into said casing so as to form a composite wick inside said heat pipe after sintering.

12. The method of claim 9, wherein the powders are selected from one of metal powders and ceramic powders, and are mixed with a solvent and a binder to form said slurry.

13. A method for forming a heat pipe, comprising:
preparing a flat tape including powders and binder binding the powders together;
rolling the flat tape onto a mandrel;
inserting the mandrel with the rolled tape thereon into a metal casing in which the rolled tape abuts against an inner wall of the casing;
heating the casing, the mandrel and the rolled tape at a sintering temperature of the powders of the tape, whereby the powders are sintered together and the binder is removed from the tape;
removing the mandrel from the casing; and
injecting working fluid into the casing and sealing the casing.

14. The method of claim 13, wherein the tape has different layers with powders of different powder sizes.

15. The method of claim 13, wherein the tape has different layers divided into different sections, the sections have powders of different powder sizes.

16. The method of claim 13, wherein a large amount of the binder accumulates on a surface of the tape to form a binding layer, the binding layer engaging the inner wall of the casing.

17. The method of claim 13, wherein the tape is made by casting a slurry consisting of the powders, the binder and a solvent, and wherein the powders, the solvent and the binder are mixed by weigh in the proportion that the powders account for 40˜80 percent, the solvent accounts for 10˜40 percent and the binder accounts for 5˜25 percent.
